(19) United States
(12) Patent Application Publication
(10) Pub. No.: US 2013/0257712 A1
(43) Pub. Date: Oct. 3, 2013

(54) ELECTRONIC DEVICE

(71) Applicant: KABUSHIKI KAISHA TOSHIBA, Tokyo (JP)

(72) Inventor: Akira Imamura, Tokyo (JP)

(73) Assignee: KABUSHIKI KAISHA TOSHIBA, Tokyo (JP)

(21) Appl. No.: 13/671,384

(22) Filed: Nov. 7, 2012

(30) Foreign Application Priority Data
Mar. 30, 2012 (JP) 2012-082470

(51) Int. Cl. G09G 5/00

(52) U.S. Cl. 345/156

(57) ABSTRACT

According to one embodiment, electronic device includes: a display; an input module; a housing; a circuit board; a battery; and an antenna. The display includes: a screen; a first surface opposite the screen; and a second surface between the screen and the first surface, and intersecting the display screen and the first surface. The housing includes: a first wall along the first surface and covering the first surface; and a second wall along the second surface intersecting the first wall and covering the second surface. The housing includes: a first member including a first area of the first wall and formed of a metallic material; and a second member including a second area surrounding the first area of the first wall and at least a portion of the second wall, and formed of a synthetic resin material. The antenna overlaps the second member.

### CROSS-REFERENCE TO RELATED APPLICATIONS

This application is based upon and claims the benefit of priority from Japanese Patent Application No. 2012-082470, filed on Mar. 30, 2012; the entire contents of which are incorporated herein by reference.

### FIELD

Embodiments described herein relate generally to an electronic device.

### BACKGROUND

Conventionally, there has been known an electronic device which accommodates a display device in a housing thereof.

In an electronic device of this type, it is desired not to cause any inconvenience such as, for example, reduction in stiffness or strength, when the thickness or the weight of the electronic device is reduced.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of an electronic device according to a first embodiment;

FIG. 2 is an exemplary side view of the electronic device in the first embodiment;

FIG. 3 is an exemplary rear view of the electronic device in the first embodiment;

FIG. 4 is an exemplary exploded perspective view of the electronic device in the first embodiment;

FIG. 5 is an exemplary cross-sectional view taken along line V-V in FIG. 1, in the first embodiment;

FIG. 6 is an exemplary front view of Components provided to a third member comprised in the electronic device, in the first embodiment;

FIG. 7 is an exemplary rear view of components provided to the third member comprised in the electronic device, in the first embodiment;

FIG. 8 is an exemplary front view of the third member comprised in the electronic device in the first embodiment;

FIG. 9 is an exemplary rear view of the third member comprised in the electronic device, in the first embodiment;

FIG. 10 is an exemplary front view (as viewed from inside the housing) of a first member and a second member comprised in the electronic device, in first the embodiment;

FIG. 11 is an exemplary schematic diagram illustrating an arrangement of an antenna in the electronic device, in the first embodiment;

FIG. 12 is an exemplary schematic diagram illustrating another arrangement of an antenna in an electronic device according to a first modification of the first embodiment;

FIG. 13 is an exemplary schematic diagram illustrating still another arrangement of an antenna in an electronic device according to a second modification of the first embodiment;

FIG. 14 is an exemplary cross-sectional view of an electronic device, taken at a position equivalent to that of FIG. 5, according to a second embodiment;

FIG. 15 is an exemplary cross-sectional view of an electronic device, taken at a position equivalent to that of FIG. 5, according to a third embodiment; and

FIG. 16 is an exemplary perspective view of an electronic device according to a fourth embodiment.

### DETAILED DESCRIPTION

In general, according to one embodiment, an electronic device comprises: a display; an input module; a housing; a circuit board; a battery; and an antenna. The display comprises: a screen; a first surface opposite the screen; and a second surface between the screen and the first surface, and intersecting the display screen and the first surface. The input module comprises a transparent portion configured to cover the screen. The housing is configured to accommodate at least a portion of the display, and comprises : a first wall along the first surface and covering the first surface; and a second wall along the second surface intersecting the first wall and covering the second surface. The circuit board is in the housing between the first surface and the first wall. The battery is in the housing and configured to be electrically connected to the circuit board. The battery is juxtaposed with the circuit board between the first surface and the first wall. The antenna is in the housing and configured to electrically connect to the circuit board. The housing comprises: a first member comprising a first area of the first wall, the first member comprising a metallic material; and a second member comprising a second area surrounding the first area of the first wall and at least a portion of the second wall, the second member comprising a synthetic resin material. The antenna overlaps the second member.

Embodiments and modifications to be described hereunder comprise similar elements. Those similar elements will be hereunder similarly designated and duplicated descriptions for those elements will be partially omitted. For convenience sake, each of the accompanying drawings is marked with direction indicating arrows (X direction, Y direction, and Z direction). The X direction extends in a long-side direction relative to a display screen 4a in a front view. The Y direction extends in a short-side direction relative to the display screen 4a in the front view. The Z direction extends in a front direction (a thickness direction of a housing 3) relative to the display screen 4a in the front view. The X direction, the Y direction, and the Z direction are orthogonal to each other.

The embodiments and modifications to be described hereunder exemplify an electronic device as being configured as so called a tablet type (straight type) or notebook type (clamshell type) personal computer. This is, however, not the only possible configuration for the electronic device of the embodiment. The electronic device in the embodiment may be configured as an electronic device of various types such as a smartphone, a smartbook, a portable phone, ,a personal digital assistant (PDA), an electronic dictionary device, a video display device, a television telephone set, and a display device having a soft keyboard.

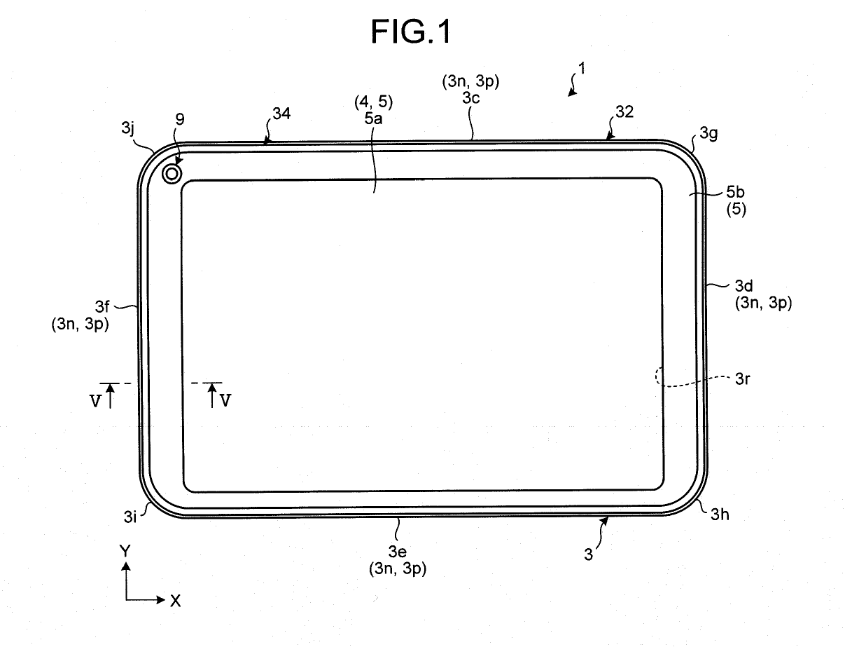

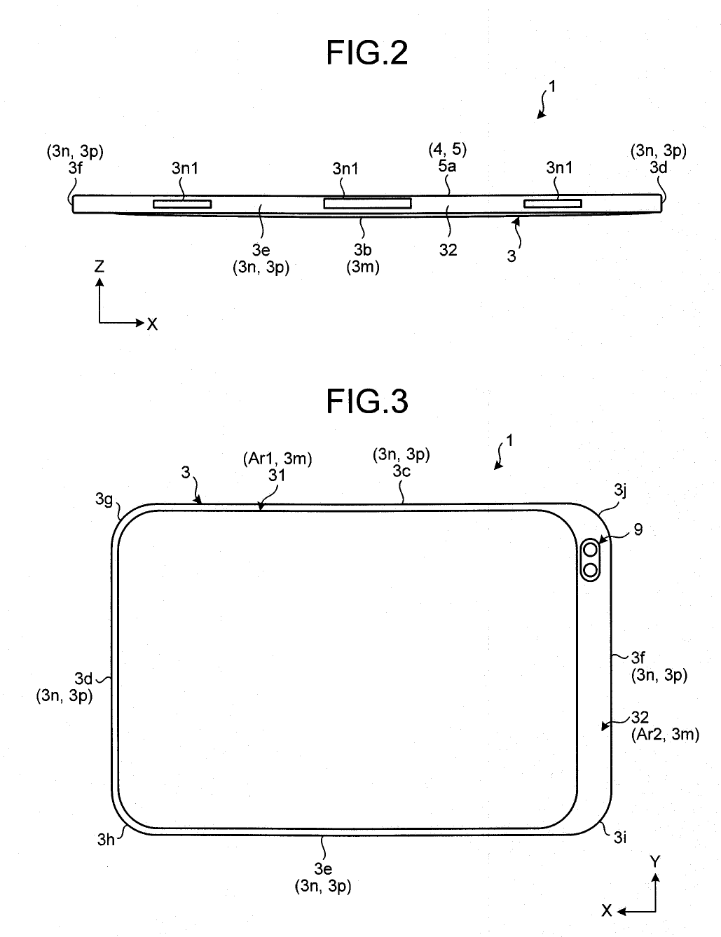

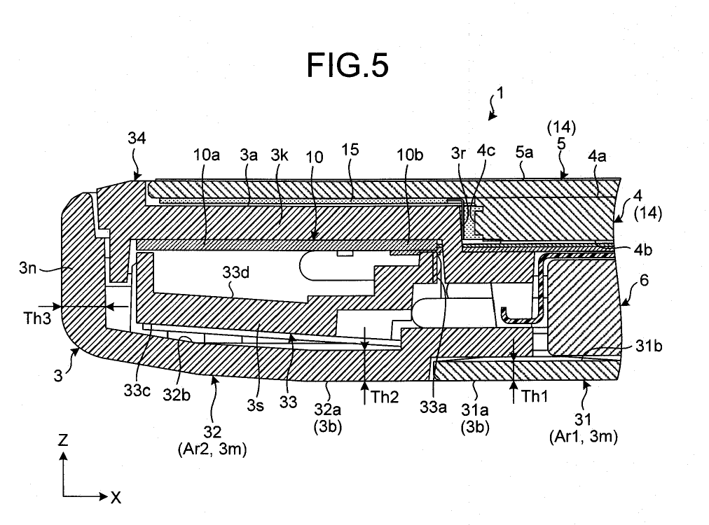

In a first embodiment, as is known from, for example, FIGS. 1 to 3, an electronic device 1 comprises the housing 3 that exemplarily has an appearance of a quadrilateral shape (exemplarily a rectangular shape in the first embodiment) in a front view and a rear view. The housing 3 is formed into a flat cuboid that is thin in a front-to-rear direction (a thickness direction or the Z direction of the housing 3). The housing 3 has a front surface 3a (a front surface, a facing surface, a surface, a surface portion; see FIG. 5) and a back surface 3b (a rear surface, a back surface, a surface, a surface portion) opposite the front surface 3a. The front surface 3a and the back surface 3b are provided at positions facing in directions opposing each other (exemplarily in parallel with each other in the first embodiment) . The housing 3 has four end portions 3c to 3f (side portions, edge portions) and four corner portions 3g to 3j (pointed portions, bent portions, end portions). The end portions 3c, 3e are exemplary long side portions. The end portions 3d, 3f are exemplary short side portions. In addition, the housing 3 has four side surfaces 3p (surfaces, surface portions) extending across the front surface 3a and the back surface 3b. It is noted that the side surfaces 3p are not necessarily clearly separated from each other and may be smoothly connected to each other via, for example, bent portions. For convenience, the upper side in FIG. 2 (a direction normal to a display surface 4a) will be hereunder referred to as a front surface side and the lower side in FIG. 2 (the side opposite to the front surface side) will be hereunder referred to as a back surface side.

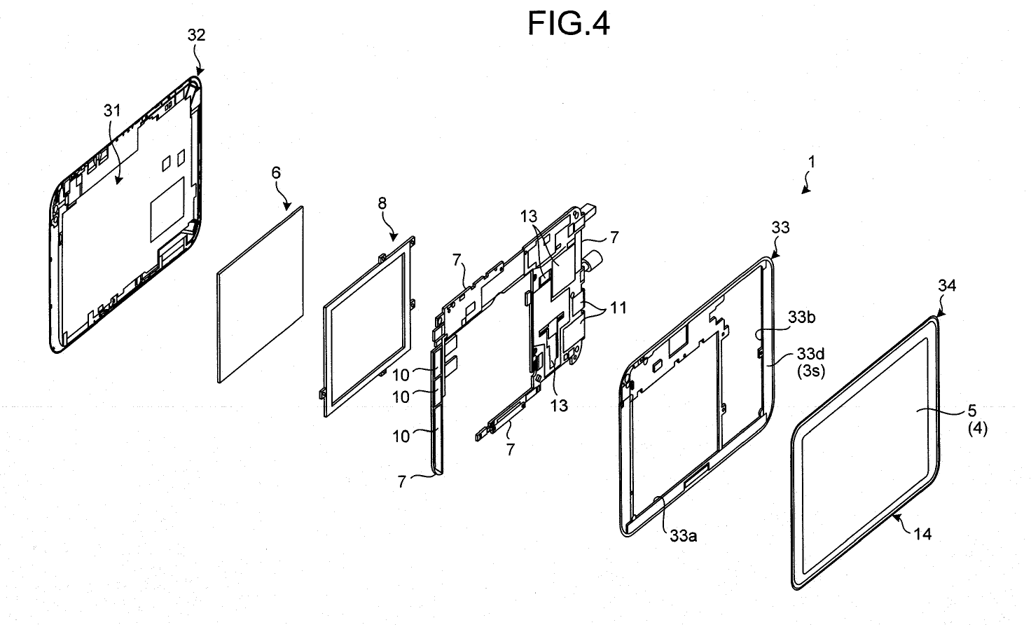

The housing 3 comprises a wall portion 3k (a part, a plate, a frame, a front wall portion, a facing wall portion, a top wall portion; see FIG. 5) positioned on the front surface side and a wall portion 3m (a part, a plate, a rear wall portion, a back wall portion, a bottom wall portion, a first wall portion) positioned on the back surface side. Each of the wall portions 3k and 3m is a quadrilateral (a rectangle as an example in the first embodiment). The wall portion 3k has a rectangular opening portion 3r. The wall portion 3k is thus formed as a rectangular frame. A display device 4 comprises the display screen 4a that is covered with a transparent portion 5a of an input operating panel 5. The display screen 4a is visually recognizable through the opening portion 3r. The wall portion 3k surrounds the display device 4. The wall portion 3m is formed as a rectangular plate. The wall portion 3m covers a back surface 4b (a back surface, a rear surface, a surface, a surface portion, a first surface) positioned opposite the display screen 4a of the display device 4. In addition, the housing 3 comprises four wall portions 3n (parts, plates, side wall portions, end wall portions, standing wall portions, extending portions, second wall portions) that extend across the wall portion 3k and the wall portion 3m. The wall portions 3n intersect the wall portion 3m and extend along a side surface 4c (a surface, a surface portion, a second surface) of the display device 4 thereby to cover the side surface 4c. It is noted that the wall portion 3m and the wall portions 3n are not necessarily clearly separated from each other, and may be smoothly connected to each other via, for example, bent portions. A cross section between the wall portion 3m and the wall portions 3n may have a continuously arcuate shape. Furthermore, the wall portion 3k and the wall portions 3n are not necessarily clearly separated from each other and may be smoothly connected to each other via, for example, bent portions. A cross section between the wall portion 3k and the wall portions 3n may have a continuously arcuate shape. In addition, as illustrated in FIG. 2, the wall portions 3n have opening portions 3n1 through which, for example, a connector or a switch (an operating portion) is exposed. Furthermore, as illustrated in, for example, FIGS. 4, 5, 8, and 9, the housing 3 comprises a wall portion 3s (a part, a plate, a frame, an intermediate wall portion, an inner wall portion, a middle plate, a middle frame, a third wall portion) positioned between the wall portion 3k and the wall portion 3m. The wall portion 3s is positioned in alignment with (exemplarily in the first embodiment in parallel with) the wall portion 3m and the wall portion 3k. The wall portions 3k, 3m, 3s expand substantially along an X-Y plane. In addition, the wall portion 3s is positioned opposite the display screen 4a of the display device 4.

Exemplarily, in the first embodiment, the housing 3 may be formed by combining a plurality of parts (a housing member, divided bodies) together, as illustrated in FIGS. 4 and 5. In the first embodiment, exemplarily, the housing 3 comprises a first member 31, a second member 32, a third member 33, and a fourth member 34. The first member 31 (a rear side member, an outside member, a sheet-shaped member, a center side member, a base, a bottom, a rear cover, a back cover) constitutes a part of the wall portion 3m. The second member 32 (a rear side member, an outside member, a frame-shaped member, a peripheral edge side member, a base, a bottom, a rear frame, a back frame) constitutes a part of the wall portion 3m and a part of the wall portion 3n. The third member 33 (an intermediate member, an inside member, a middle frame, a middle plate) constitutes a part of the wall portion 3s positioned between the wall portion 3k and the wall portion 3m. The fourth member 34 (a front side member, an outside member, a frame-shaped member, a front cover, a front bezel) constitutes a part of the wall portion 3k. The members (exemplarily, in the first embodiment, the first member 31, the second member 32, the third member 33, and the fourth member 34) constituting the housing 3 are joined to each other through, for example, connection through fitting (snap fit) , bonding, or welding, or with a fixture (e.g., a screw or a clip).

As an example, in the first embodiment, the first member 31 is formed of a metallic material, while the second member 32, the third member 33, and the fourth member 34 are formed of a synthetic resin material (plastic, engineering plastic). In the first embodiment, therefore, exemplarily, reduction in weight and thickness of the housing 3 tends to be easily made compatible with improved stiffness and strength thereof. Examples of the metallic material include, but not limited to, an aluminum alloy, a magnesium alloy, and stainless steel. Compared with the second member 32, the third member 33, and the fourth member 34, the first member 31 has a high electrical conductivity (has electrical conductivity), a low transmissivity of electromagnetic waves (transmits substantially no electromagnetic waves or blocks the electromagnetic waves), a high thermal conductivity, and a high density (specific gravity). In other word, the second member 32, the third member 33, and the fourth member 34 have a low electrical conductivity (has no electrical conductivity), a high transmissivity of electromagnetic waves (transmit electromagnetic waves), a low thermal conductivity, and a low density (specific gravity), compared with the first member 31.

As an example, in the first embodiment, at least a part of the display device 4 (a display portion, a display, a panel, a display part) is housed in the housing 3 as illustrated in FIG. 4. A user can visually recognize the display screen 4a via the opening portion 3r from the front surface side (forward side). The display device 4 has an appearance of a quadrilateral shape (exemplarily a rectangular shape in the first embodiment) in the front view. In addition, the display device 4 is formed into a flat cuboid that is thin in a front-to-rear direction (the Z direction, or the thickness direction of the housing 3). The display device 4 may, for example, be a liquid crystal display (LCD) or an organic electroluminescent display (OELD). Furthermore, in the first embodiment, the relatively thin, quadrilateral input operating panel 5 (a touch panel, a touch sensor, an operating surface, an input operating portion, an input accepting portion, an input portion, an input device) having a transparent portion is provided to the front surface side (a front side, a facing side) of the display device 4.

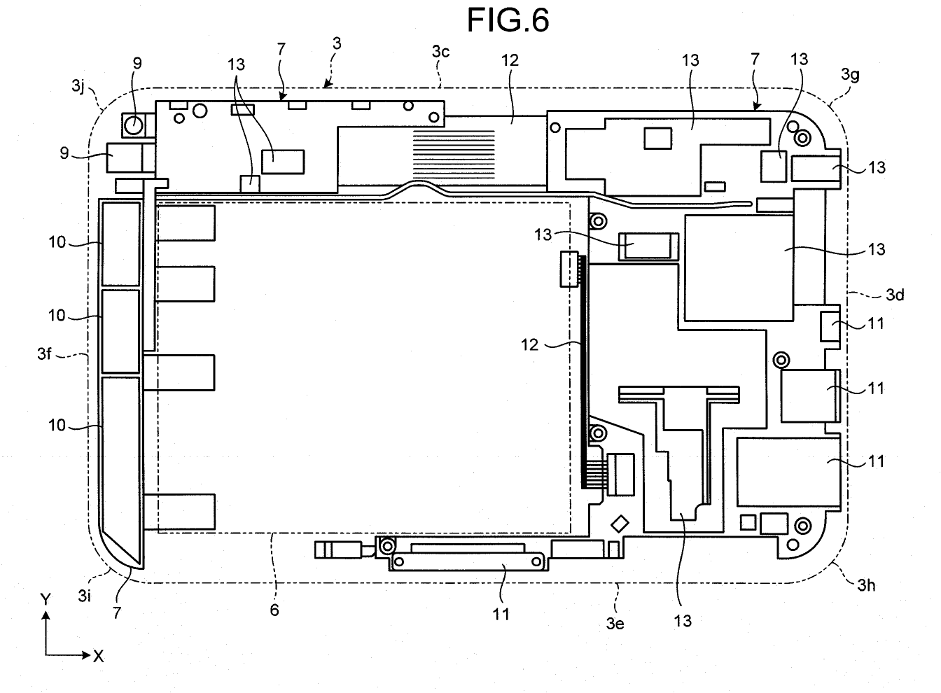

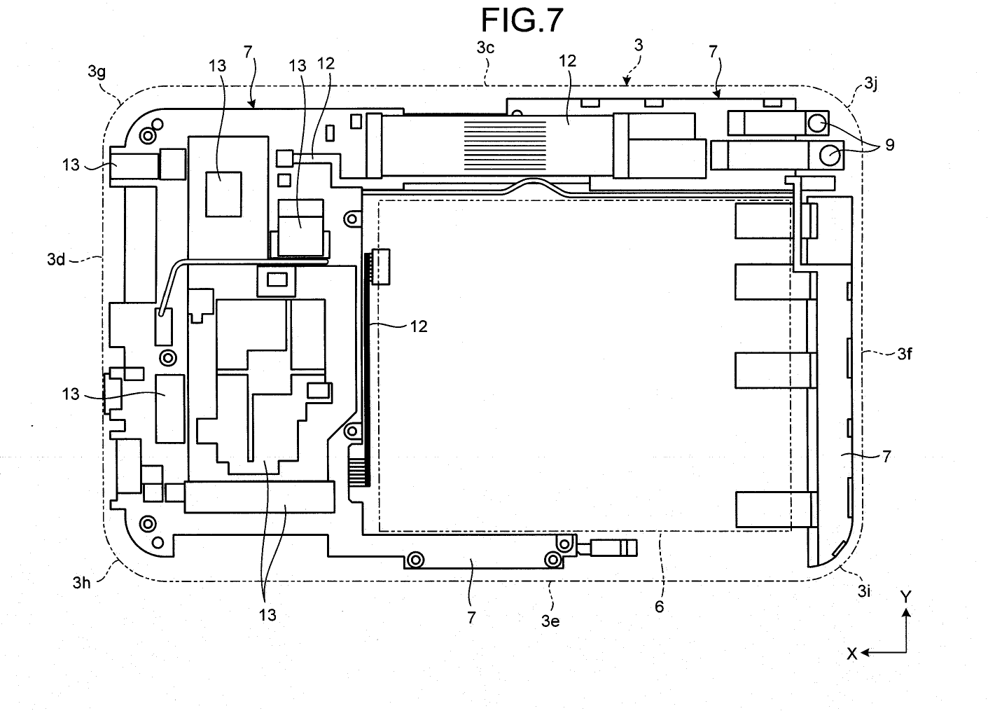

As an example, in the first embodiment, electrical components including, but not limited to, a battery 6 (a cell, a battery pack, a module, a battery module, a battery unit), a substrate 7 (a circuit board, a printed circuit board, a control board), a battery frame 8 (a frame, a bracket, a mounting component), a camera module 9 (a camera unit, a camera assembly, an imaging device), an antenna module 10 (an antenna unit, an antenna assembly, an antenna device, an antenna), and a connector module 11 (a connector unit, a connector assembly, a connected device, a connector) are contained in the housing 3 on a rear side (a back side, a behind side, a side of the wall portion 3m, a side opposite to the display screen 4a) of the display device 4 as electrical components as illustrated in, for example, FIGS. 4 to 9. Each of these electrical components is electrically connected to each other via a wiring 12 (e.g., a cable, a flexible cable, and a flexible printed wiring board). In addition, for example, a speaker module (a speaker unit, a speaker assembly, a voice output device) or a vibration generator (exemplarily, a motor having an eccentric weight mounted on a rotational shaft), though not illustrated, may be housed inside the housing 3. Furthermore, as illustrated in FIGS. 6 and 7, various types of components 13 (for example, electrical components, electronic components, elements, chips, packages) are provided (mounted) to the substrate 7.

As an example, in the first embodiment, the battery 6 illustrated in FIGS. 4 and 5 can be configured as a lithium ion secondary battery. Exemplarily, in the first embodiment, the battery 6 can supply, via the wiring 12, the electrical components provided in the housing 3, in addition to the display device 4, with power supply electricity that is required by the electronic device 1 to perform such operations as displaying an image or outputting voice. The battery 6 can also supply electricity to, for example, an external device connected to, for example, the substrate 7 via the wiring 12, a conductive part (a busbar, not illustrated) , the connector module 11, or the like. As an example, in the first embodiment, as illustrated in FIG. 4, the battery 6 has an appearance of a quadrilateral shape in a front view and a rear view and a flat shape that is thin in the thickness direction of the housing 3. The battery frame 8 is formed into a quadrilateral frame shape extending along a peripheral edge portion of the battery 6.

As an example, in the first embodiment, as illustrated in FIGS. 6 and 7, for example, a central processing unit (CPU), a graphic controller, a power supply circuit component, a platform controller hub (PCH), a memory slot connector, an LCD connector, an input/output (I/O) connector, a power supply coil, an element, a connector, and a plurality of other components 13 may be mounted on the substrate 7. The components 13 comprise a heat generating body. In addition, a cooling device (a cooling mechanism, not illustrated) may be provided to (the components 13 of) the substrate 7. The cooling device may, for example, comprise a plate-like portion and a cooling sheet. The plate-like portion is formed of a material having a high thermal conductivity (e.g., an aluminum alloy or other metallic material). The cooling sheet is bonded to, or otherwise provided to, one surface (the surface on the side of the substrate 7) of the plate-like portion and has elasticity (flexibility).

As an example, in the first embodiment, the substrate 7 and the components 13 constitute at least a part of a control circuit (not illustrated). In addition, examples of the control circuit may include a video signal processing circuit, a tuner portion, a high-definition multimedia interface (HDMI) signal processing portion, an audio video (AV) input terminal, a remote control signal receiving portion, a control portion, a selector, an on-screen display interface, a storage portion (e.g., a flash memory, a read only memory (ROM)), a random access memory (RAM), a hard disk drive (HDD)), and a voice signal processing circuit. The control circuit controls, for example, an output of an image (a video, a still image, or the like) on the display screen 4a of the display device 4, an output of voice through a speaker (not illustrated) , and illumination at a light emitting diode (LED, not illustrated). The display device 4, the speaker, and the LED, for example, are exemplary output portions.

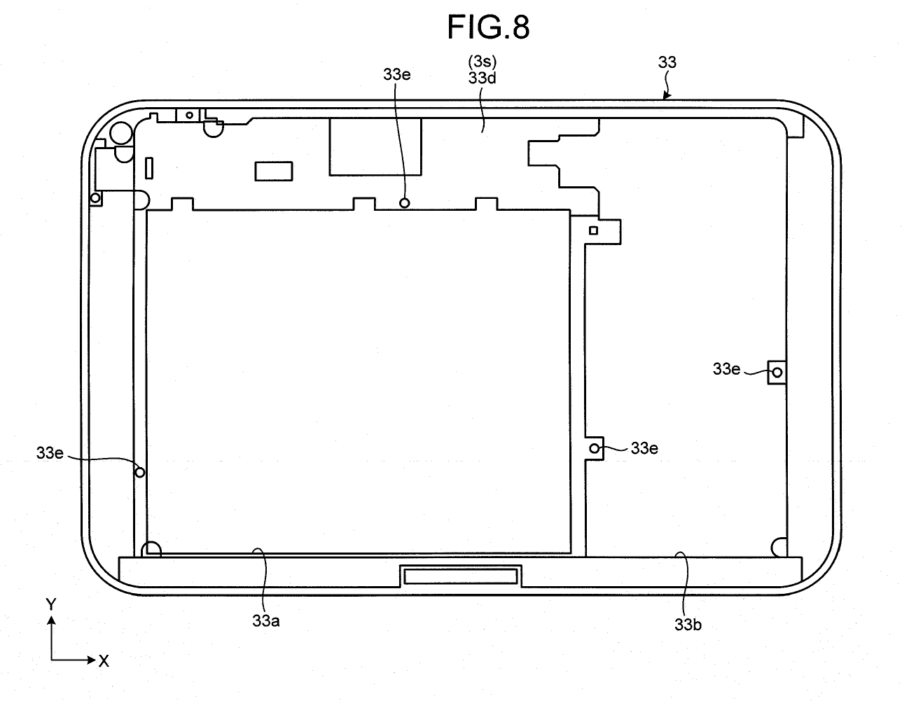

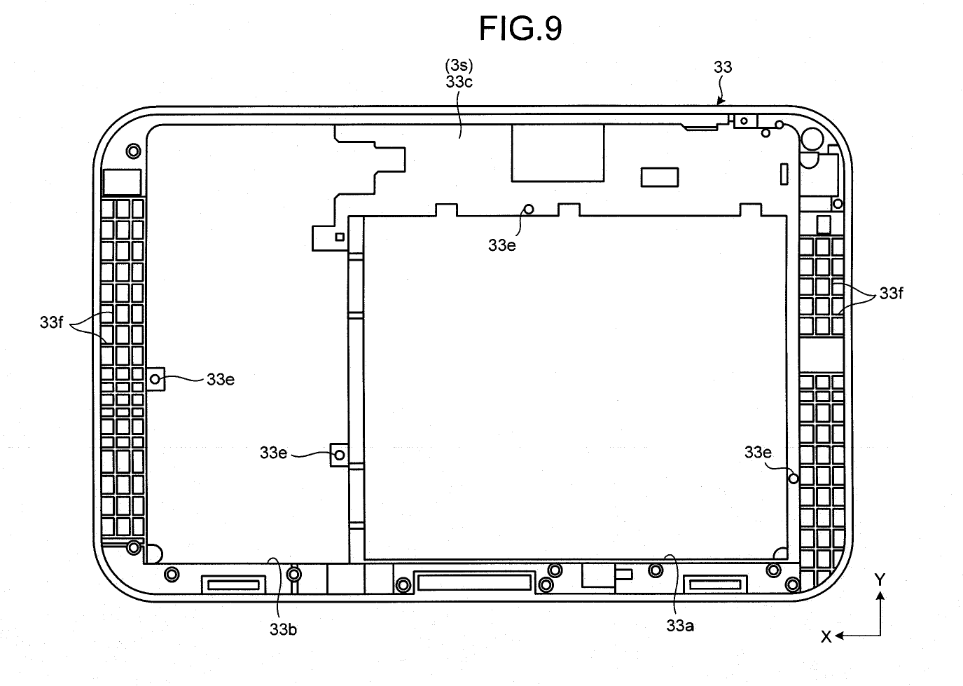

As an example, in the first embodiment, the substrate 7, the battery 6, the display device 4, and other components are fixed to (mounted on) the third member 33 illustrated in FIGS. 8 and 9 using fixtures (e.g., screws). The third member 33 has opening portions 33a, 33b. The third member 33 is thus formed into a frame. The opening portion 33a is covered, with the battery 6 (see FIG. 4) and the opening portion 33b is covered with the substrate 7 (see FIG. 4). As illustrated in FIG. 4, the battery 6 and the substrate 7 are mounted on the side of a back surface 33c (a rear surface, a surface, a surface portion) of the wall portion 3s. The display device 4 is positioned on a front surface 33d (a front surface, a facing surface, a surface, a surface portion) of the wall portion 3s. The display device 4 and the input operating panel 5 are integrated with each other thereby to constitute a panel unit 14 (subassembly). As illustrated in FIG. 5, the input operating panel 5 is positioned on the front surface side (the front side) of the display device 4 and protrudes to the side of a peripheral edge portion of (sideways) the display device 4. An area of the input operating panel 5 that overlaps the display screen 4a is the transparent portion 5a. The transparent portion 5a is surrounded by a peripheral edge portion 5b that protrudes toward the outside of the display screen 4a of the display device 4 (in a direction away from the center of the display screen 4a). As an example, in the first embodiment, the peripheral edge portion 5b of the input operating panel 5 (the panel unit 14) is attached to the front surface 33d of the wall portion 3s via an elastic and flexible adhesive sheet 15. In addition, exemplarily, in the first embodiment, the wall portion 3s has mounting portions 33e (exemplarily, in the first embodiment, opening portions, through holes, cutouts, and the like) as illustrated in FIGS. 8 and 9. In addition, as illustrated in FIG. 9, the wall portion 3s has ribs 33f (wall portions, protruding portions). The ribs 33f improve stiffness of the wall portion 3s (the third member 33).

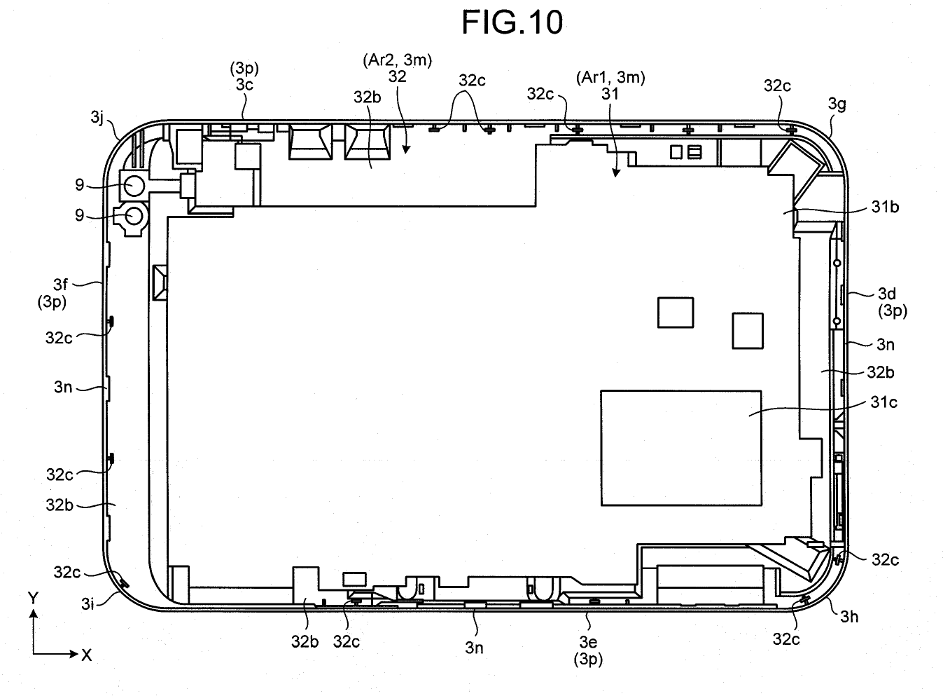

As an example, in the first embodiment, as illustrated in FIGS. 3, 4, 5, and 10, for example, the first member 31 and the second member 32 constitute the wall portion 3m and the wall portions 3n of the housing 3. The wall portion 3m comprises the first member 31 and the second member 32, while the wall portions 3n comprise the second member 32. As illustrated in FIGS. 3 and 10, an area of the first member 31 in the wall portion 3m is a first area Ar1 and an area of the second member 32 in the wall portion 3m is a second area Ar2. The second area Ar2 surrounds the first area Ar1. The first area Ar1 (the first member 31) is a quadrilateral plate shape, while the second area Ar2 (the second member 32) is a quadrilateral frame shape. In addition, the second area Ar2 extends along a plurality of (exemplarily, in the first embodiment, four) end portions 3c to 3f (the side portions) of the housing 3. The end portions 3c to 3f comprise the second member 32. The second area Ar2 extends across two adjacent end portions (the end portion 3c and the end portion 3d, the end portion 3d and the end portion 3e, the end portion 3e and the end portion 3f, and the end portion 3f and the end portion 3c) via the respective corner portions 3g to 3j. As such, exemplarily, in the first embodiment, the first member 31 constitutes the central portion side of the wall portion 3m and the second member 32 constitutes the side opposite the central portion (the outside) of the wall portion 3m, the second member 32 extending across a peripheral edge portion of the wall portion 3m and the wall portions 3n. In addition, an inner surface 32b (a surface, a surface portion) of the second member 32 has, for example, ribs 32c (wall portions, protrusions) that extend across the wall portion 3m and the wall portions 3n. Furthermore, an outer surface 31a (a surface, a facing surface, a back surface, a rear surface, a surface portion) of the first member 31 and an outer surface 32a (a surface, a facing surface, a back surface, a rear surface, a surface portion) of the second member 32 adjacent thereto are formed to be smoothly continuous with each other (in a condition of being continuous or flush with each other, or having substantially no angular changes) except for boundaries thereof.

As an example, the first member 31 is formed of a metallic material, such as an aluminum alloy or a magnesium alloy, as described earlier. Exemplarily, the first member 31 may be formed through, for example, rolling or press-forming. In addition, the first member 31 may be formed through, for example, diecasting. Rolling or press-forming may reduce trouble and cost of manufacturing, compared with diecasting. The second member 32 is formed, exemplarily, of a synthetic resin material, such as a thermoplastic resin or a crystalline resin as described earlier. Exemplarily, the second member 32 may be formed through injection molding.

As an example, in the first embodiment, the first member 31 in the wall portion 3m has a thickness Th1 (an average thickness in a general portion of the first area Ar1) that is thinner (smaller) than a thickness Th2 of the second member 32 in the wall portion 3m (an average thickness in a general portion (an area having no ribs, protrusions, or the like) of the second area Ar2) . The second member 32 in the wall portion 3n has a thickness Th3 that is thicker (greater) than the thickness Th2 of the second member 32 in the wall portion 3m. Specifically, Th1 <Th2<Th3 holds for the thickness of the wall portions 3m, 3n.

As described above, exemplarily, in the first embodiment, the central portion of the wall portion 3m is formed of a metallic material (the first member 31) and the peripheral edge portion of the wall portion 3m is formed of a synthetic resin material (the second member 32). The housing 3 therefore tends to have improved stiffness compared with an arrangement in which the central portion of the wall portion 3m is formed of a synthetic resin material. Specifically, in terms of achieving equivalent stiffness, the housing 3 tends to be built thinner in the arrangement in which the central portion of the wall portion 3m is formed of a metallic material than in the arrangement in which the central portion of the wall portion 3m is formed of a synthetic resin material. In addition, as an example, in the first embodiment, the peripheral edge portion of the wall portion 3m, and the wall portions 3n are formed integrally (continuously, through molding using the same material and the same molding process) of a synthetic resin material. Consequently, exemplarily, in the first embodiment, stiffness of the peripheral edge portion of the wall portion 3m, and the wall portions 3n can be even further enhanced, including an effect from the ribs or irregular surface structures provided on the peripheral edge portion of the wall portion 3m, and the wall portions 3n.

As an example, in the first embodiment, the central portion of the wall portion 3m is formed of a material (an electromagnetic shielding material, a conductive material, conductor, a metallic material, the first member 31) having a better electromagnetic shielding property than the synthetic resin material (the second member 32) . Consequently, as an example, an effect from external noise on, for example, the substrate 7, the camera module 9, the connector module 11, and the components 13 (electrical components, electronic components) housed in the housing 3 and an effect of noise from the housing 3 on the outside can be reduced.

As an example, in the first embodiment, the central portion of the wall portion 3m is formed of a material (a conductive material, a conductor, a metallic material, the first member 31) having a higher conductivity than the synthetic resin material (the second member 32) . Consequently, as an example, the central portion of the wall portion 3m can be easily shared by a plurality of portions within the housing 3 (components, electrical components, electronic components, the substrate 7, and the like) for ground potential. It is noted that, as illustrated in FIG. 10, a portion of an inner surface 31b of the first member 31 facing the components 13 (a portion opposing the components 13) has an exposed portion 31c that has not been subjected to surface treatment. Portions other than the exposed portion 31c have been subjected to surface treatment for creating insulating coating. The exposed portion 31c is thus a conductive portion.

In addition, as an example, in the first embodiment, the central portion of the wall portion 3m is formed of a material (a metallic material, the first member 31) having a higher thermal conductivity than the synthetic resin material (the second member 32) . Consequently, as an example, a heat generating body housed inside the housing 3, such as the battery 6 or the components 13 (electrical components, electronic components) , faces the material having the higher thermal conductivity, so that heat generated in the heat generating body tends to be transferred to the outside of the housing 3 via the central portion of the wall portion 3m. As an example, the inside of the housing 3 can therefore be prevented from overheating. Furthermore, as an example, in the first embodiment, the peripheral edge portion (an outer edge portion, an edge portion, a periphery) of the wall portion 3m is formed of a material (a synthetic resin material, the second member 32) having a lower thermal conductivity than a metallic material (the first member 31). As an example, therefore, heat is less likely to be transferred to the user who has a greater chance of holding onto the peripheral edge portion of the wall portion 3m than with the central portion thereof.

In addition, as an example, in the first embodiment, the second member 32, the battery 6, and the substrate 7 are positioned so as to be out of position from each other (so as not to overlap each other) in a line of sight along the width direction of the housing 3 (a front view relative to the display screen 4a, Z direction) as illustrated in FIGS. 5, 6, and 7. As an example, therefore, the second member 32 can be set to have a greater thickness without allowing the housing 3 to be very thick. Exemplarily, therefore, the housing 3 can be set to offer even greater stiffness. Furthermore, such arrangements allow an even greater effect to be achieved in terms of electromagnetic shielding property, conductivity, and thermal conductivity.

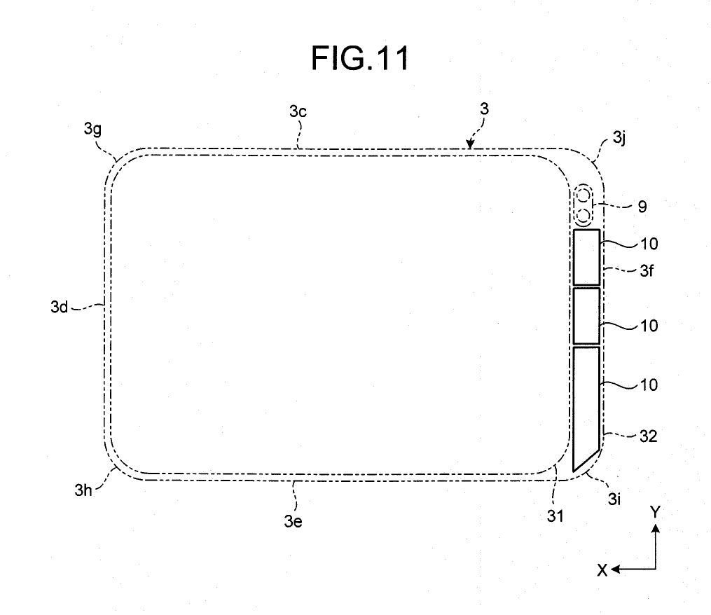

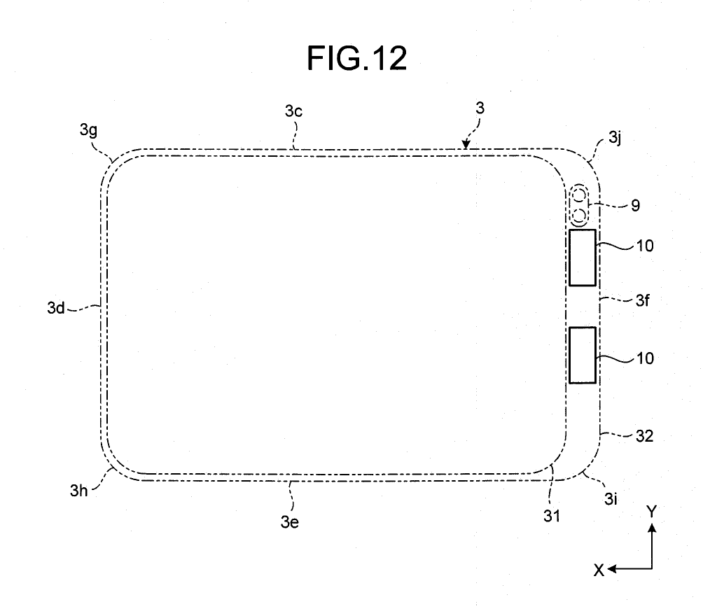

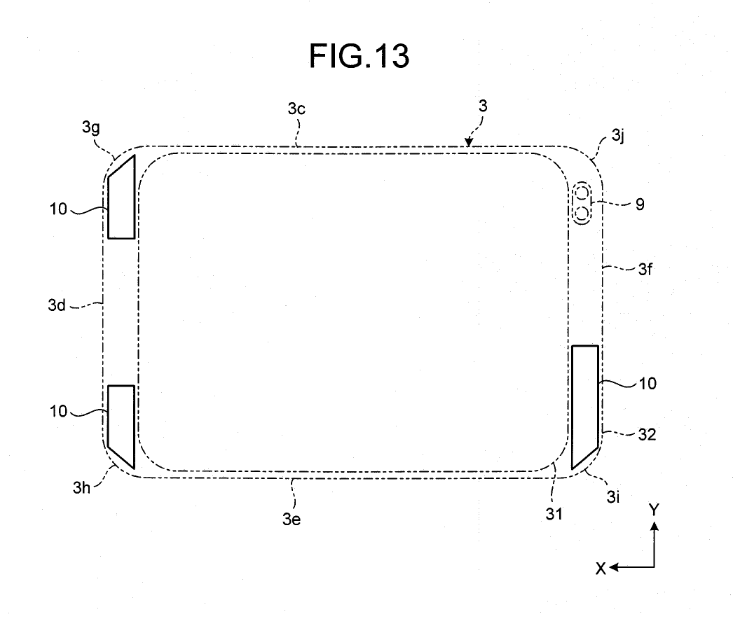

In addition, as an example, in the first embodiment, the antenna module 10 is provided inside the housing 3 using the arrangement of the first member 31 and the second member 32. Specifically, as an example, in the first embodiment, as illustrated in FIGS. 6 and 11, a plurality of antenna modules 10 (antennas) are provided on and along the end portion 3f as an extension of the second member 32. As an example, in the first embodiment, the antenna module 10 comprises a communication portion 10a (an area excluding an antenna portion, a ground portion (ground electrode), and a supporting portion 10b (a root portion); an end portion away from the center of the housing 3) that overlaps not the first member 31 but the second member 32 in a line of sight along the width direction of the housing 3 (a front view relative to the display screen 4a, Z direction). As an example, such an arrangement prevents communication (transmission and reception) performed by the antenna module 10 from being impaired by the first member 31. In addition, exemplarily, in the first embodiment, the second member 32 is provided across the end portion 3e and the end portion 3f via the corner portion 3i. This causes the antenna module 10 to tend to be positioned toward the side of the corner portion 3i. As an example, in the first embodiment, improved, efficiency easily results in placing components inside the housing 3. Furthermore, as an example, in the first embodiment, the antenna module 10 positioned at the corner portion 3i is even further away from, for example, the components 13 inside the housing 3. Consequently, as an example, inconveniences, such as noise contamination and interference, can be prevented from occurring in, for example, the antenna module 10 and the components 13. In addition, in an exemplary arrangement in which the antenna modules 10 are mounted to cope with a various types of communication systems (e.g., a wireless local area network (LAN), third generation mobile telecommunications (3G), long term evolution (LTE), a global positioning system (GPS), and television broadcasting) or in which the antenna modules 10 are mounted to cope with diversity, the antenna modules 10 can be easily positioned efficiently in the housing 3. It is noted that the entire range of the antenna module 10 and its communication portion 10a does not necessarily overlap the second member 32 in the thickness direction of the housing 3. The degree of overlap therebetween is set, as appropriate, within a range of causing no or less problems. In addition, as illustrated in a first modification illustrated in FIG. 12, the number of antenna modules 10 may be changed as appropriate. As illustrated in a second modification illustrated in FIG. 13, the antenna modules 10 may be provided to the end portions 3d, 3f on both sides in the long-side direction. As an example, as illustrated in FIGS. 11 to 13, in the end portions 3d, 3f, an area in which the antenna module 10 is provided may be separated from an area in which the camera module 9 is provided. In addition, if a vertical direction of the electronic device in normal use (posture of the housing 3) is established in a posture of the long-side direction facing sideways, it is more convenient for easier imaging by the camera module 9, if the camera module 9 is positioned on the upper side (the upper side in FIGS. 11 to 13) and the antenna module 10 is positioned on the lower side (the lower side in FIGS. 11 to 13). Furthermore, the second member 32 is provided across the end portion 3f and the end portion 3c via the corner portion 3j. The camera module 9 is thus easily positioned toward the corner portion 3j.

The antenna module 10 may be of various specifications (e.g., shape, size, thickness, system, and quantity) , including, but not limited to, an even slender antenna module, a more compact antenna module, an antenna module comprising a communication device positioned on one side, an antenna module inclined along the housing 3, a bent antenna module, and a curved antenna module. The antenna module 10 may also be shaped in various ways in a plan view.

In addition, as an example, in the first embodiment, as illustrated in FIG. 6, the antenna module 10 is positioned on the side of the battery 6 opposite the substrate 7. Specifically, the battery 6 is positioned between the antenna module 10 and the substrate 7. Therefore, exemplarily, in the first embodiment, a problem of, for example, noise contamination and interference between, for example, the antenna module 10 and the components 13 provided on the substrate 7 is less likely to occur.

In addition, as an example, in the first embodiment, referring to FIG. 6, the connector module 11 is positioned on the substrate 7 opposite the battery 6. Therefore, as an example, in the first embodiment, the connector module 11 is easily provided to the substrate 7. Alternatively, the wiring 12 between the connector module 11 and the components 13 on the substrate 7 can be made even shorter.

In addition, as an example, in the first embodiment, as illustrated in FIG. 6, the connector module 11, the substrate 7, the battery 6, and the antenna module 10 are arranged in juxtaposition with each other along the long-side direction of the housing 3. Consequently, as an example, the first embodiment is advantageous in terms of, for example, the short wiring 12, layout of components, and noise contamination and interference.

As described above, in the first embodiment, as an example, the housing 3 comprises the first member 31 formed of a metallic material to have the first area An of the wall portion 3m and the second member 32 formed of a synthetic resin material to have the second area Ar2 surrounding the first area Ar1 of the wall portion 3m and at least a part of the wall portions 3n, and the antenna module 10 is positioned so as to overlap the second member 32. Therefore, in the first embodiment, as an example, the first member 31 formed of the metallic material helps to prevent interference occurred in communication performed by the antenna module 10.

In addition, in the first embodiment, as an example, at least a portion of the second area Ar2 is positioned along the end portions 3c to 3f of the wall portion 3m and the antenna modules 10 are positioned along the end portions 3c to 3f. Therefore, in the first embodiment, as an example, the antenna modules 10 can be even more efficiently positioned within the housing 3.

In addition, in the first embodiment, as an example, the first area An (the first member 31) faces the substrate 7. Specifically, in the first embodiment, as an example, the components 13 provided on the substrate 7 are covered with the first area Art. Consequently, in the first embodiment, as an example, an effect of the electromagnetic waves on the components 13 on the substrate 7 or an effect of the electromagnetic waves from the components 13 can be easily reduced. Furthermore, the first area Ar1 can be used as a ground for the components 13 provided on the substrate 7. Further as an example, heat generated from a heat generating body, such as the components 13 provided on the substrate 7, is easily transferred to the first area Ar1. This contributes for example to improved heat dissipation.

In addition, in the first embodiment, exemplarily, the housing 3 comprises the wall portion 3s to which the display device 4, the substrate 7, and the battery 6 are connected. The housing 3 further comprises the third member 33 covered with the first member 31 and the second member 32. Therefore, in the first embodiment, as an example, the third member 33 helps various types of components be supported even more efficiently or even more rigidly inside the housing 3.

In addition, in the first embodiment, as an example, the housing 3 comprises the fourth member 34 that is positioned at the peripheral edge portion of the display screen 4a, that covers the side opposite the wall portion 3m of the third member 33, and that is connected to the display device 4 and the second member 32. Therefore, in the first embodiment, as an example, an even simpler arrangement can be achieved for covering the side of the display screen 4a of the housing 3.

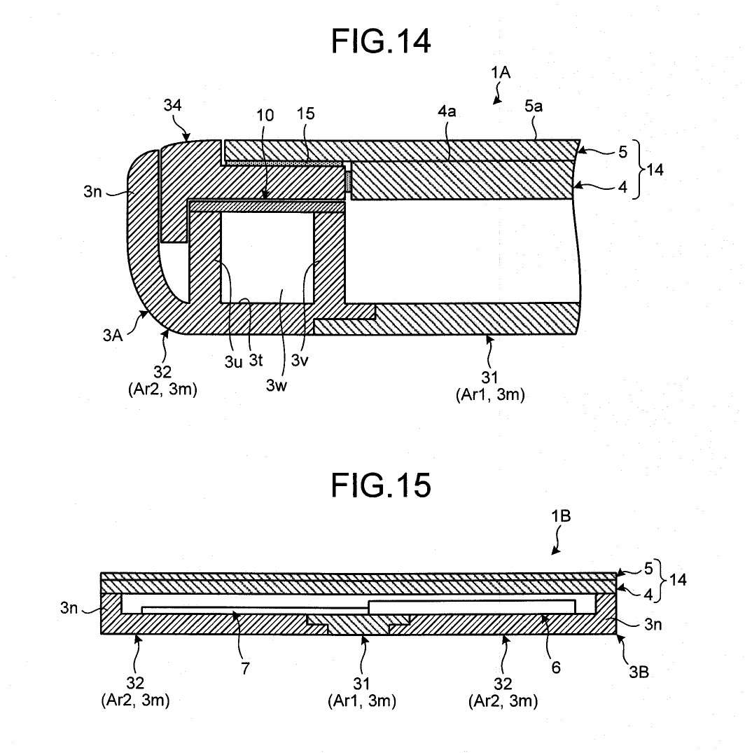

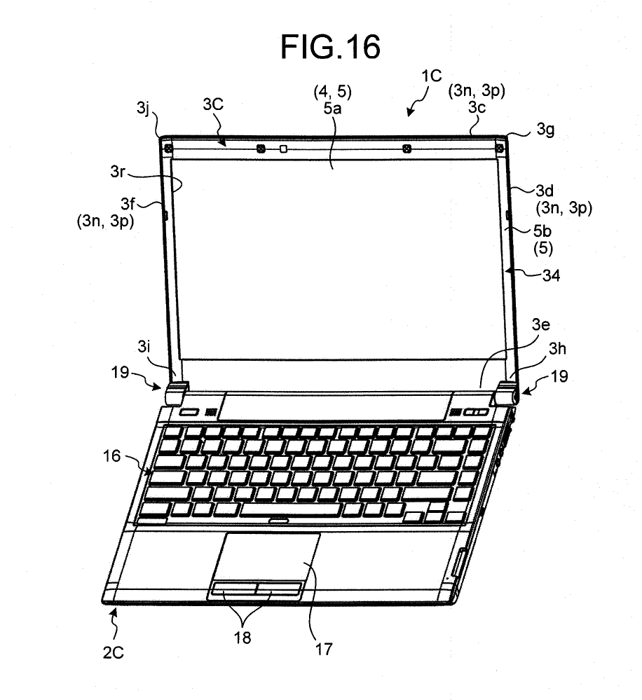

In an electronic device 1A according to a second embodiment, as an example, the second member 32 has wall portions 3u, 3v (ribs, protruding portions) that protrude from an inner surface 3t of a housing 3A, as illustrated in FIG. 14. These wall portions 3u, 3v extend along and substantially in parallel with the wall portion 3n, and with a spacing therefrom. A wall portion 3w (a rib, a protruding portion) that joins together the wall portions 3u, 3v is provided therebetween, extending in a direction intersecting the wall portions 3u, 3v (in the second embodiment, exemplarily, in an orthogonal direction). In addition, the wall portion 3v is positioned so as to overlap (or at a position near) a joint between the first member 31 and the second member 32. In the second embodiment, as an example, the second member 32, having, for example, the wall portions 3u, 3v, 3w, offers even more enhanced stiffness and, for that matter, the housing 3A offers even more enhanced stiffness. The antenna module 10 is provided to the wall portions 3u, 3v. The antenna module 10 is thus supported even more stably by the housing 3A. The electronic device 1A in the second embodiment, too, can achieve similar results based on the arrangements similar to those of the electronic device 1 of the first embodiment described earlier.

In an electronic device 1B according to a third embodiment, as an example, the first member 31 (the first area Ar1) is narrow (small) as illustrated in FIG. 15 compared with the above-described embodiments. In a housing 3B, the flat battery 6 and the flat substrate 7 mounted with components (not illustrated) (and components inside the housing 3B) are provided in contact with the inner surface 3t. The battery 6 and the substrate 7 are, as an example, bonded to the inner surface 3t of the wall portion 3m via, for example, an adhesive or a sheet-shaped joining member. Consequently, as an example, an arrangement for providing the battery 6, the substrate 7, and other components in the housing 3B can be easily simplified. As an example, therefore, reduction in weight or thickness of the electronic device 1B can be easily achieved. In addition, in the third embodiment, as an example, the display device 4 and the input operating panel 5 (the panel unit 14, a subassembly) is fixed (coupled, connected, mounted) on the wall portion 3n of the second member 32. The electronic device 1B in the third embodiment, too, can achieve similar results based on the arrangements similar to those of the electronic devices 1, 1A of the above-described embodiments.

While certain embodiments have been described, these embodiments have been presented by way of example only, and are not intended to limit the scope of the invention. Indeed, the novel methods and systems described herein may be embodied in a variety of other forms; furthermore, various omissions, substitutions, and changes in the form of the methods and systems described herein may be made without departing from the spirit of the invention. The accompanying claims and their equivalents are intended to cover such forms or modifications as would fall within the scope and spirit of the invention. The present invention is not duly limited to the exemplary embodiments set forth herein and various modifications and alterations may be made therein. For example, even if the first member is formed of any material other than the metallic material (e.g., a material containing carbon fiber, a synthetic resin material containing filler that enhances, for example, stiffness, electromagnetic shielding property, conductivity, and thermal conductivity), the similar results as those of the above-described embodiments can be obtained. If both the first member and the second member are formed of a synthetic resin material (or a synthetic resin-based material), the wall portions of the housing can be formed through what-is-called two-color molding. Furthermore, the second member may still be formed of any material other than the synthetic resin material. The present invention can also be applied to an electronic device 10 according to a fourth embodiment in which a housing 2C and a housing 3C are rotatably connected together via a hinge portion 19 to form a folding type (notebook type, clamshell type) configuration (the housing 3C). The housing 2C has a keyboard 16, a pointing device 17 (a touchpad), a click button 18, and other components as an input operating portion (an input portion, an input accepting portion). The housing 3C accommodates, for example, the display device 4, the input operating panel 5, a substrate (not illustrated), and an antenna (not illustrated). Technical characteristics of each of the above-described embodiments may be combined or replaced with each other as appropriate to carry out the invention. The arrangements and specifications of different portions (e.g., structure, type, direction, shape, size, length, width, thickness, height, quantity, disposition, position, and material) maybe changed as appropriate to carry out the invention.

Moreover, the various modules of the systems described herein can be implemented as software applications, hardware and/or software modules, or components on one or more computers, such as servers. While the various modules are illustrated separately, they may share some or all of the same underlying logic or code.

What is claimed is:

1. An electronic device comprising:
a display comprising:
a screen;
a first surface opposite the screen; and
a second surface between the screen and the first surface, the second surface configured to intersect the display screen and the first surface;
an input module comprising a transparent portion configured to cover the screen;
a housing configured to accommodate at least a portion of the display, the housing comprising:
a first wall along the first surface and covering the first surface; and
a second wall along the second surface intersecting the first wall and covering the second surface;
a circuit board in the housing between the first surface and the first wall;
a battery in the housing configured to electrically connect to the circuit board, the battery juxtaposed with the circuit board between the first surface and the first wall; and
an antenna in the housing, the antenna configured to electrically connect to the circuit board, wherein
the housing comprises:
a first member comprising a first area of the first wall, the first member comprising a metallic material; and
a second member comprising a second area surrounding the first area of the first wall and at least a portion of the second wall, the second member comprising a synthetic resin material; and
the antenna overlaps the second member.

2. The electronic device of claim 1, wherein at least a portion of the antenna is at a corner of the housing.

3. The electronic device of claim 1, wherein
at least a portion of the second area is along an end of the first wall; and
the antenna comprises a plurality of antennas along the end.

4. The electronic device of claim 1, wherein the antenna is opposite the battery with respect to the circuit board.

5. The electronic device of claim 1, wherein the first area faces the circuit board.

6. The electronic device of claim 1, further comprising a connector opposite the battery with respect to the circuit board, the connector configured to electrically connect to the circuit board.

7. The electronic device of claim 1, further comprising a third member comprising a third wall connected to the display, the circuit board, and the battery, the third member covered by the first member and the second member.

8. The electronic device of claim 7, further comprising a fourth member at a periphery of the screen, the fourth member covering a side of the third member opposite the first wall and connected to the display and the second member.

9. An electronic device comprising:
a display comprising:
a screen;
a first surface opposite the screen; and
a second surface between the screen and the first surface, the second surface configured to intersect the display screen and the first surface;
a housing configured to accommodate at least a portion of the display, the housing comprising:
a first wall along the first surface and covering the first surface; and
a second wall along the second surface intersecting the first wall and covering the second surface; and
an electrical component in the housing between the first surface and the first wall, wherein
the housing comprises:
a first member annularly along an end of the first wall, the first member comprising a first material; and
a plate-like second member toward a center of the first wall relative to the first member, the plate-like second member comprising a second material.

10. An electronic device comprising:
a display comprising:
a screen;
a first surface opposite the screen; and
a second surface between the screen and the first surface, the second surface configured to intersect the display screen and the first surface;
a housing configured to accommodate at least a portion of the display, the housing comprising:
a first wall along the first surface and covering the first surface; and
a second wall along the second surface intersecting the first wall and covering ₜhe second surface; and
an electrical component in the housing between the first surface and the first wall, wherein
the housing comprises:
a first member along a plurality of ends of the first wall adjacent to each other, the first member comprising a synthetic resin material; and
a second member toward a center of the first wall relative to the first member, the second member comprising a metallic material.
